(19) United States
(12) Patent Application Publication
(10) Pub. No.: US 2014/0306984 A1
(43) Pub. Date: Oct. 16, 2014

(54) DISPLAY DEVICE AND DRIVING METHOD THEREOF

(71) Applicant: Samsung Display Co., Ltd., Yongin-City (KR)

(72) Inventors: Jae-Suk Choi, Uijeongbu-si (KR); Hoi Sik Moon, Asan-si (KR); Woo-Young Lee, Hwaseong-si (KR); Kang-Hyun KIM, Seoul (KR); Woo-Jin Jung, Seoul (KR); Jae-Seob Chung, Asan-si (KR)

(73) Assignee: Samsung Display Co., Ltd., Yongin-City (KR)

(21) Appl. No.: 13/956,630

(22) Filed: Aug. 1, 2013

(30) Foreign Application Priority Data
Apr. 10, 2013 (KR) 10-2013-0039345

(51) Int. Cl. G09G 5/06

(52) U.S. Cl. CPC G09G 5/06
USPC 345/591; 345/602

(57) ABSTRACT

Disclosed are a display device and a driving method thereof. The display device includes: a first lookup table that stores first color compensation data optimized to display a first color; a second lookup table that stores second color compensation data optimized to display a second color different from the first color; and a color compensating unit that refers to the first lookup table and the second lookup table.

### CROSS REFERENCE TO RELATED APPLICATION

This application claims priority from and the benefit of Korean Patent Application No. 10-2013-0039345, filed on Apr. 10, 2013, which is hereby incorporated by reference for all purposes as if fully set forth herein.

### BACKGROUND

1. Field

Exemplary embodiments of the invention relate to a display device and a driving method including a color compensation method.

2. Description of the Background

Display devices, such as a liquid crystal display (LCD), an organic light emitting diode display, and the like, generally include a display panel including a plurality of pixels, a plurality of signal lines, and a driving unit that drives the display panel. Each pixel may include counter electrodes and switching elements connected to the signal lines, the pixel electrodes, and the counter electrodes. The driving unit may include a gate driver that supplies a gate signal to the display panel, a data driver that supplies a data signal to the display panel, a signal controller that controls the data driver and the gate driver, and the like.

A pixel electrode may be connected to the switching elements, such as a thin film transistor TFT, to be applied with data voltage. The counter electrode may be formed over the display panel and may be applied with common voltage Vcom. The pixel electrode and the counter electrode may be disposed on the same substrate or on different substrates.

For example, a LCD may include two display panels and a liquid crystal layer having dielectric anisotropy interposed therebetween. Pixel electrodes may be arranged on one of the display panels in a matrix form, and may be connected to the switching elements, such as the thin film transistor (TFT), so as to be sequentially applied with data voltage row by row. The counter electrode may be formed on the other display panel, and may be applied with the common voltage Vcom. The pixel electrode and the counter electrode may be applied with a differential voltage to generate an electric field in the liquid crystal layer. A strength of the electric field may be controlled to control transmittance of light passing through the liquid crystal layer, thereby obtaining a desired image.

The display device may receive image signals of a plurality of primary colors, such as red, green, and blue, from an external graphics source. A signal controller of the display device may appropriately process an image signal so as to meet characteristics of the display panel, and may then provide the processed image signal to the data driver. The data driver may select an analog voltage corresponding to the image signal, and may apply the selected analog voltage as the data signal to the display panel of the display device.

The processing of the image signal may include adaptive color correction (ACC) that compensates for a difference in gamma curves of each primary color to remove a problem in that color feeling is changed for each gray level. Temperature or color characteristics of gray level-based colors, such as white, gray, and the like, may be corrected by independently controlling the gamma curves of each primary color during ACC processing

In addition to the above, a display device, and, in particular, a LCD, may have more degraded side visibility than front visibility. In order to improve the side visibility, there is a need to divide one pixel into two sub-pixels and change pixel voltage of the two sub-pixels.

The above information disclosed in this Background section is only for enhancement of understanding of the background of the invention and therefore it may contain information that does not form prior art that is already known to a person of ordinary skill in the art.

### SUMMARY

Exemplary embodiments of the invention provide a display device having improved color characteristics.

Additional features of the invention will be set forth in the description which follows, and in part will be apparent from the description, or may be learned by practice of the invention.

Exemplary embodiments of the invention disclose a display device including a first lookup table, a second look table, and a color compensating unit. The first lookup table (LUT) is configured to store first color compensation data for displaying a first color. The second lookup table is configured to store second color compensation data for displaying a second color different from the first color. The color compensating unit is configured to receive the first color compensation data and the second color compensation data and to convert an input image signal into a compensated image signal.

Exemplary embodiments of the invention also disclose a driving method of a display device. The driving method includes converting an input image signal into a compensated image signal according to a first color compensation data stored in a first lookup table (LUT) and a second color compensation data stored in a second lookup table (LUT). The first color compensation data includes data for displaying a first color and the second color compensation data includes data for displaying a second color different from the first color.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram of a display device according to exemplary embodiments of the invention.

FIG. 2 is a diagram illustrating two sub-pixels included in one pixel of the display device according to exemplary embodiments of the invention.

FIG. 3 is a graph illustrating a gamma curve of the display device according to exemplary embodiments of the invention.

FIG. 4 is a diagram illustrating one example of a lookup table for color compensation of the display device according to exemplary embodiments of the invention.

FIG. 5 is a diagram illustrating one example of the lookup table for specific color compensation of the display device according to exemplary embodiments of the invention.

FIG. 6 is a block diagram of a color compensating unit of the display device according to exemplary embodiments of the invention.

FIG. 7 is a flow chart illustrating a color compensation method in the display device according to exemplary embodiments of the invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It may also be understood that for the purposes of this disclosure, “at least one of X, Y, and Z” can be construed as X only, Y only, Z only, or any combination of two or more items X, Y, and Z (e.g., XYZ, XYY, YZ, ZZ).

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the invention.

The terminology used herein is for the purpose of describing exemplary embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, exemplary embodiments of the invention should not be construed as limited to the particular shapes of regions illustrated herein but are to include deviations in shapes that result, for example, from manufacturing.

Hereinafter, a display device and a driving method thereof according to exemplary embodiments of the invention will be described in detail with reference to the accompanying drawings.

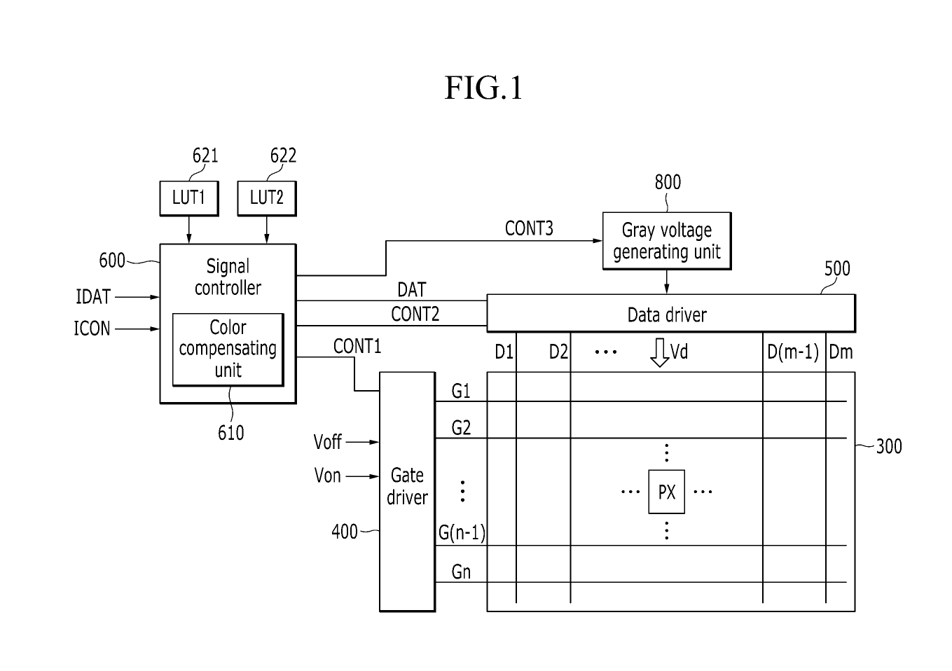

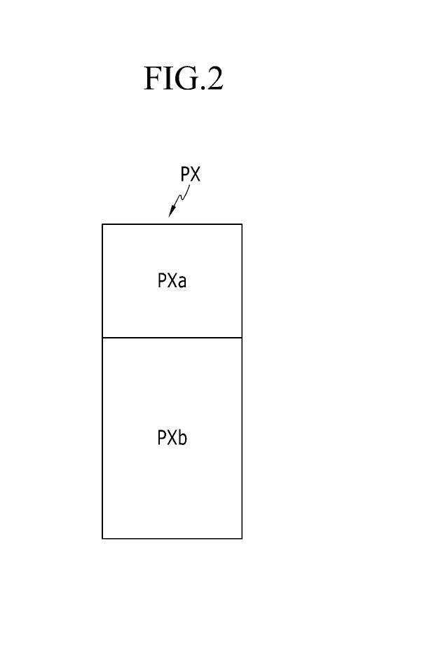

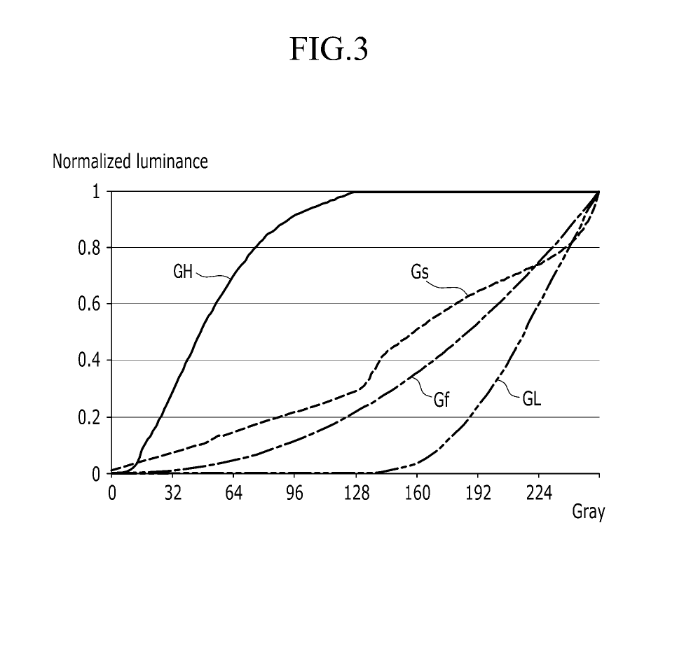

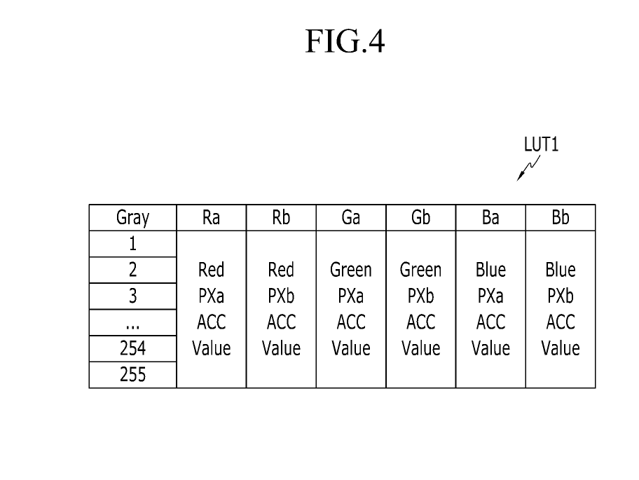

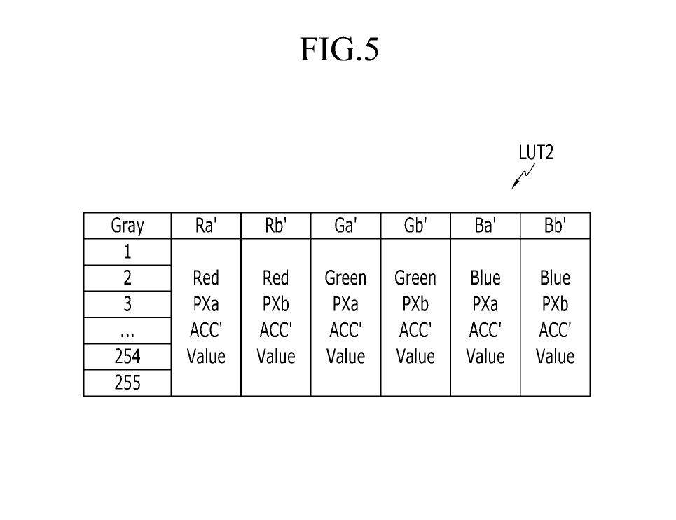

FIG. 1 is a block diagram of a display device according to exemplary embodiments of the invention. FIG. 2 is a diagram illustrating two sub-pixels included in one pixel of the display device according to exemplary embodiments of the invention. FIG. 3 is a graph illustrating a gamma curve of the display device according to exemplary embodiments of the invention. FIG. 4 is a diagram illustrating one example of a lookup table for color compensation of the display device according to exemplary embodiments of the invention. FIG. 5 is a diagram illustrating one example of the lookup table for specific color compensation of the display device according to exemplary embodiments of the invention.

Referring to FIG. 1, a display device may include a display panel 300, a gate driver 400, a data driver 500, a gray voltage generator 800, a signal controller 600, a first lookup table (first LUT) 621, and a second lookup table (second LUT) 622. The gate driver 400 and the data driver 500 may be connected to the display panel 300. The gray voltage generator 800 may be connected to the data driver 500. The signal controller 600 controls the various components of the display device including the display panel 300, the gate driver 400, the data driver 500, the gray voltage generator 800, the first LUT 621, and the second LUT 622.

The display panel 300 may include a plurality of signal lines and a plurality of pixels PX connected to the plurality of signal lines. The pixels PX may be arranged substantially in a matrix form. If the display device is a LCD, the display panel 300 may include a lower panel, an upper panel (not illustrated) facing the lower panel, and a liquid crystal layer (not illustrated) interposed between the upper and lower panels.

The plurality of signal lines may include a plurality of gate lines G1 to Gn that transfer gate signals (referred to as “scanning signal”) and a plurality of data lines D1 to Dm that transfer data voltages.

Each of the pixels PX may include at least one switching element (not illustrated) connected to at least one data line of the data lines D1 to Dm, at least one gate line of the gate lines G1 to Gn, and at least one pixel electrode (not illustrated). The switching element may be, for example, a thin film transistor (TFT), and may be controlled by the gate signals and data voltages.

Each of the pixels PX may display (spatial division) a primary color or may alternately display (temporal division) primary colors over time, such that the desired colors may be recognized by the spatial and temporal sum of these primary colors. An example of the primary colors may include colors such as red, green, and blue. Adjacent pixels PXs that display different primary colors may form one set (referred to as dot) together, in which one dot may display a white image.

Referring to FIG. 2, one pixel PX of a display device may include a first sub-pixel PXa and a second sub-pixel PXb. The first sub-pixel PXa and the second sub-pixel PXb may display images according to different gamma curves and images having the same gamma curve, for one input image signal IDAT. An area of the first sub-pixel PXa may be the same or different than an area of the second sub-pixel PXb. It should also be understood that although FIG. 2 shows a pixel having a first sub-pixel PXa and a second sub-pixel PXb, various numbers of sub-pixels may be arranged in a single pixel PX.

One pixel PX may output an image according to different gamma curves or the same gamma curve for two or more consecutive frames for the one input image signal IDAT.

FIG. 3 illustrates an example of different gamma curves for one input image signal IDAT. Referring to FIG. 3, different gamma curves applied to different spaces or at different times for the one input image signal IDAT may include first and second gamma curves GH and GL, as illustrated in FIG. 3. The first and second gamma curves GH and GL may be adjusted so that a synthesized gamma curve at fronts of the first and second gamma curves GH and GL coincides with a front gamma curve Gf (for example, a gamma curve of which the gamma value is 2.2) that may be most appropriate for the display device and a synthesized gamma curve at sides thereof that coincides with a side gamma curve Gs and that maximally approaches the front gamma curve Gf so as to improve the side visibility of the display device.

Referring back to FIG. 1, the gray voltage generator 800 may generate gray voltages associated with a transmittance of the pixels PX or a limited number of gray voltages (referred to as reference gray voltages). The reference gray voltage may include a gray voltage corresponding to a common voltage Vcom having a positive value or a negative value. The gray voltage generator 800 may receive gamma data and may generate reference gray voltages based on the received gamma data.

The data driver 500 is connected to the data lines D1 to Dm and may select a gray voltage from the gray voltage generator 800 based on an output image signal DAT received from the signal control unit 600. The data driver 500 may apply the selected gray voltage as data voltage Vd to the data lines D1 to Dm. When the gray voltage generator 800 does not provide all the gray voltages but provides only a limited number of reference gray voltages, the data driver 500 may divide the reference gray voltages to generate the gray voltages for all the grays and select a data voltage Vd among the gray voltages.

The gate driver 400 is connected to the gate lines G1 to Gn to apply gate signals to the gate lines G1 to Gn. The gate signals may be a combination of a gate-on voltage Von and a gate-off voltage Voff.

The signal controller 600 may receive the input image signal IDAT and an input control signal ICON from a graphic controller (not illustrated), and may control the gate driver 400, the data driver 500, and the gray voltage generator 800 accordingly.

The graphic controller may process received image data to generate the input image signal IDAT, and may then transmit the input image signal IDAT to the signal controller 600. For example, the graphic controller may perform a frame rate control to insert an intermediate frame between neighboring frames to reduce motion blur in an image.

The input image signal IDAT may include luminance information for each pixel PX, in which the luminance has a defined number of gray levels. Input image signals IDAT may be provided for each primary color that is displayed by the pixel PX. For example, when the input image signal IDAT includes a red image signal, a green image signal, or a blue image signal, the pixel PX may output a corresponding primary color (e.g., red, green, and blue).

An example of the input control signal ICON may include a vertical synchronization signal, a horizontal synchronization signal, a main clock signal, a data enable signal, and the like.

The signal controller 600 may convert the input image signal IDAT based on the input image signal IDAT and the input control signal ICON, and may generate a gate control signal CONT1, a data control signal CONT2, a output image signal DAT, a gamma control signal CONT3, and the like. The data control signal CONT2 may further include an inversion signal that inverts a polarity of the data voltage Vd for the common voltage Vcom. The gamma control signal CONT3 may include gamma data for the gamma curve.

The signal controller 600 may include a color compensating unit 610 that performs color compensation processing on the received input image signal IDAT in the display panel 300. The color compensating unit 610 may refer to the first LUT 621 and the second LUT 622, which store information regarding characteristics of the display panel 300, to convert the input image signals IDAT for each primary color into compensated image signals, thereby compensating for the gamma of the input image signals IDAT.

Referring to FIG. 4, the first LUT 621 (i.e., LUT1) may include first color compensation data for the input image signals IDATs for each primary color. The first color compensation data may be ACC data that are optimized for gray-based colors, such as white, and the like, and may uniformly represent the color characteristics at the fronts and sides of the gray-based colors. The color compensating unit 610 may refer to the first color compensation data stored in the first LUT 621 to perform the color compensation. The first LUT 621 may be the same as the LUT used in various ACC methods.

When one pixel PX includes the first sub-pixel PXa and the second sub-pixel PXb, the first color compensation data may be present for the first sub-pixel PXa and the second sub-pixel PXb, respectively. When one pixel PX or each sub-pixel PXa and PXb displays images for at least two consecutive frames for the one input image signal IDAT, the first color compensation data may also be present for the at least two consecutive frames, respectively.

FIG. 4 illustrates the first LUT 621 storing first color compensation data Ra, Rb, Ga, Gb, Ba, and Bb for each sub-pixel PXa and PXb of each primary color R, G, and B when the one pixel PX includes the first sub-pixel PXa and the second sub-pixel PXb. Ra represents ACC data of a first red sub-pixel PXa; Rb represents ACC data of a second red sub-pixel PXb; Ga represents ACC data of a first green sub-pixel PXa; Gb represents ACC data of a second green sub-pixel PXb; Ba represents ACC data of a first blue sub-pixel PXa; and Bb represents ACC data of a second blue sub-pixel PXb. When one pixel PX displays an image according to different gamma curves or the same gamma curve for at least two consecutive frames for one input image signal IDAT, the ACC data may also be present for different frames.

Referring to FIG. 5, the second LUT 622 may include second color compensation data optimized for a specific color. The second color compensation data may be ACC data that is optimized for a predetermined specific color, not for gray-based colors, such as white, and the like, and may uniformly represent the color characteristics at the fronts and sides of the specific color. The specific color may be freely selected, for example, a skin color of a person. The LUT values of the second LUT 622 may be different from those of the first LUT 621.

When one pixel PX includes the first sub-pixel PXa and the second sub-pixel PXb, the first color compensation data and the second color compensation data may be present for the first sub-pixel PXa and the second sub-pixel PXb, respectively. When one pixel PX or each sub-pixel PXa and PXb displays images for at least two consecutive frames for the one input image signal IDAT, the second color compensation data may also be present for the at least two consecutive frames, respectively.

FIG. 5 illustrates the second LUT 622 (i.e., LUT2), in which the second color compensation data Ra′, Rb′, Ga′, Gb′, Ba′, and Bb′ for each sub-pixel PXa and PXb of each primary color R, G, and B is stored. When the one pixel PX includes the first sub-pixel PXa and the second sub-pixel PXb. Ra′ represents ACC′ data of the first red sub-pixel PXa; Rb′ represents ACC′ data of the second red sub-pixel PXb; Ga′ represents ACC′ data of the first green sub-pixel PXa; Gb′ represents ACC′ data of the second green sub-pixel PXb; Ba′ represents ACC′ data of the first blue sub-pixel PXa; and Bb′ represents ACC′ data of the second blue sub-pixel PXb. The ACC′ data of the second LUT 622 may be different from the ACC data of the first LUT 621. When a pixel PX displays an image according to gamma curves for at least two consecutive frames for the one input image signal IDAT, the ACC data may also be present for different frames.

FIGS. 4 and 5 each illustrate an example in which the number of gray levels is 256, however, the number of gray levels may be various and is not limited thereto.

In addition, FIG. 4 illustrates an example in which first color compensation data are present for all the gray levels. However, in some cases, the first color compensation data may be present for only some of the gray levels. In this case, the first color compensation data for the remaining gray levels may be obtained using an interpolation method, and the like. Likewise, FIG. 5 illustrates an example in which the first color compensation data are present for all the gray levels. However, in some cases, the first color compensation data may be present for only some of the gray levels. In this case, the first color compensation data for the remaining gray levels may be obtained using an interpolation method, and the like.

The first LUT 621 and the second LUT 622 may be stored in one or more Electrically Erasable Programmable Read-Only Memories (EEPROMs), or any other suitable storage device. In some cases, the first LUT 621 and the second LUT 622 may be included in the signal controller 600 or the color compensating unit 610.

Next, the driving method of the display device will be described.

The signal controller 600 may receive an input image signal IDAT and an input control signal ICON from a graphic controller, and the like. The signal controller 600 may is control the color compensating unit 610 to perform color compensation processing, and the like, thereby converting the input image signal IDAT into the output image signal DAT and generating the gate control signal CONT1, the data control signal CONT2, the gamma control signal CONT3, and the like. The signal controller 600 may transmit the gate control signal CONT1 to the gate driver 400, the data control signal CONT2 and the output image signal DAT to the data driver 500, and the gamma control signal CONT3 to the gray voltage generator 800.

The signal controller 600 may receive the input image signal IDAT and the input control signal ICON controlling the display thereof from an external component, such as a graphics controller. The signal controller 600 may convert the input image signal IDAT into the output image signal DAT, and may generate the gate control signal CONT1, the data control signal CONT2, and the like. The signal controller 600 may transmit the gate control signal CONT1 to the gate driver 400, and the data control signal CONT2 and the output image signal DAT to the data driver 500.

The gray voltage generator 800 may generate a gray voltage or a limited number of reference gray voltages depending on the gamma control signal CONT3, and may transmit the generated gray voltage(s) or reference gray voltage(s) to the data driver 500. Gray voltage may be prepared for different gamma curves, respectively, and may also be generated for gamma curves selected through a separate selection process.

The data driver 500 may receive the output image signal DAT for the pixels PX of one row according to the data control signal CONT2 from the signal controller 600, and may select the gray voltage corresponding to each output image signal DAT to convert the output image signal DAT into the analog data voltage Vd and then apply the analog data voltage Vd to the corresponding data lines D1 to Dm.

The gate driver 400 may apply the gate-on voltage Von to the gate lines G1 to Gn depending on the gate control signal CONT1 received from the signal controller 600 to turn-on the switching element connected to the gate lines G1 to Gn. Next, the data voltage Vd applied to the data lines D1 to Dm is applied to the corresponding pixel PX through the turned-on switching element. When the data voltage Vd is applied to the pixel PX, the pixel PX may display the luminance corresponding to the data voltage Vd through various optical conversion elements. For example, in the case of a LCD, a gradient of the liquid crystal molecules of the liquid crystal layer is controlled to control the polarization of light, thereby displaying the luminance corresponding to the gray level of the input image signal IDAT.

By repeating the process based on 1 horizontal period (1H), which is the same as one period of a horizontal synchronizing signal Hsync and a data enable signal DE, the gate-on voltage Von is sequentially applied to all the gate lines G1 to Gn and the data voltage Vd is applied to all the pixels PXs to display the image of one frame.

When one frame is completed, a next frame starts and a state of an inversion signal included in the data control signal CONT2 may be controlled so that the polarity of the data voltage Vd applied to each pixel PX is opposite to the polarity of the data voltage Vd in a previous frame (referred to as a frame inversion). During frame inversion, the polarity of the data voltage Vd applied to all the pixels PX may be inverted at every frame. The polarity of the data voltage Vd applied to one of the data lines D1 to Dm is periodically changed or the polarity of the data voltage Vd applied to the data lines D1 to Dm of one pixel row may be different from each other according to the characteristics of the inversion signal in one frame.

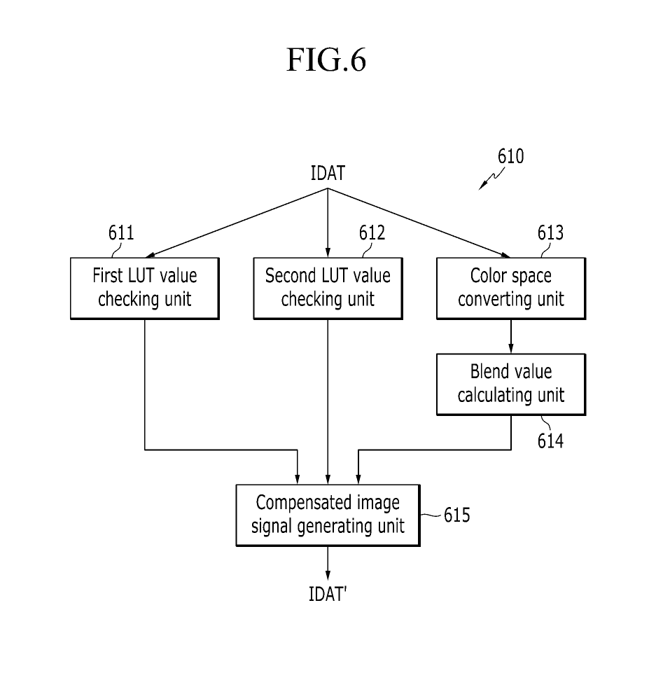

Next, the color compensating unit of the display device according to exemplary embodiments of the invention will be described in more detail with reference to FIG. 6, along with the above-mentioned drawings.

FIG. 6 is a block diagram of the color compensating unit 610 of the display device according to exemplary embodiments of the invention. Although the color compensating unit 610 is shown in FIG. 1 as being part of the signal controller 600, exemplary embodiments of the invention are not limited thereto. It should be understood that the color compensating unit 610 may be implemented in various manners, including, for example, being a separate unit from the signal controller 600.

Referring to FIG. 6, the color compensating unit 610 of the display device may include a first LUT value checking unit 611, a second LUT value checking unit 612, a color space converting unit 613, a blend value calculating unit 614, and a compensated image signal generating unit 615. The color compensating unit 610 and each one of its components may be implemented as any combination of software and/or hardware (e.g., general processor, Digital Signal Processing (DSP) chip, an Application Specific Integrated Circuit (ASIC), Field Programmable Gate Arrays (FPGAs), etc.), firmware, or a combination thereof. In this manner, the color compensating unit 610 may include or otherwise be associated with one or more memories (e.g., hard disk, magnetic tape, any other magnetic medium, non-transitory computer-readable storage medium) including code (e.g., instructions) configured to execute the operations described hereinbelow. In some cases, the color compensating unit 610 and each one of its components may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like. For example, in some cases, the color compensating unit 610 may include one or more processors configured to execute the operations of the color compensating unit 610 as described in further detail below. In some cases, each of the first LUT value checking unit 611, a second LUT value checking unit 612, a color space converting unit 613, a blend value calculating unit 614, and a compensated image signal generating unit 615 may be an individual processor configured to execute the operations of the respective unit as described in further detail below.

In response to receiving the input image signal IDAT, the first LUT value checking unit 611 may check the first LUT 621 to obtain the first color compensation data for at least one of each primary color, each sub-pixel, and each frame.

In response to receiving the input image signal IDAT, the second LUT value checking unit 612 may also check the second LUT 622 to obtain the second color compensation data for at least one of each primary color, each sub-pixel, and each frame.

The color space converting unit 613 may convert the input image signal IDAT into a predetermined specific color space. The specific color space may be, for example, a HSV (HSB) color space. In the HSV color space, “H” represents hue, “S” represents saturation, and “V” or “B” represents value or brightness. The hue H is represented by a relative disposition angle when a red color having the longest wavelength is set to be 0° in a hue circle when a visible ray spectrum is disposed in a ring shape, and ranges from 0° to 360°. The saturation S may be represented by a thick degree when the thickest state of the specific color is set to be 100%. A saturation of 0% represents an achromatic color of the same brightness. The brightness B represents a degree of the brightness when white is set to be 100% and black is set to be 0%.

The blend value calculating unit 614 may receive the HSV value converted into the HSV color space from the color space converting unit 613 to calculate the blend value VB that indicates how close the color represented by the input image signal IDAT is to the predefined specific color. The blend value may range from 0 to 1.

For example, when the color represented by the input image signal IDAT is the same as the predefined specific color, the blend value VB is 1. When the color represented by the input image signal IDAT may be farthest away from the predefined specific color in the HSV color space, the blend value VB may be 0. Accordingly, the blend value VB may serve as a weight value that indicates how close the color represented by the input image signal IDAT is to the specific color.

The compensated image signal generating unit 615 may generate a compensated image signal IDAT′ using the first color compensation data for the input image signal IDAT obtained by the first LUT value checking unit 611, the second color compensation data for the input image signal IDAT obtained by the second LUT value checking unit 612, and the blend value VB. For example, when the blend value VB is 0, the first color compensation data may be output as the compensated image signal IDAT′. When the blend value VB is 1, the second color compensation data may be output as the compensated image signal IDAT′. When the color represented by the input image signal IDAT is somewhat close (e.g., similar) to the specific color, the first color compensation data and the second color compensation data may be multiplied by each weight value and then added to be output as the compensated image signal IDAT′.

The compensated image signal IDAT′ may be calculated using the following Equation 1.

Rout=VB×R_{—}spe+(1−VB)×R_white

Gout=VB×G_{—}spe+(1−VB)×G_white

Bout=VB×B_{—}spe+(1−VB)×B_white [Equation 1]

In Equation 1, the example in which the input image signal IDAT includes the input image signals for red R, green G, and blue B, respectively, is shown. R_spe, G_spe, and B_spe represent the second color compensation data for the input image signal IDAT obtained in the second LUT value checking unit 612. R_white, G_white, and B_white represent the first color compensation data for the input image signal IDAT obtained in the first LUT value checking unit 611. Rout, Gout, and Bout represent the compensated image signals IDAT′ for red R, green G, and blue B, respectively.

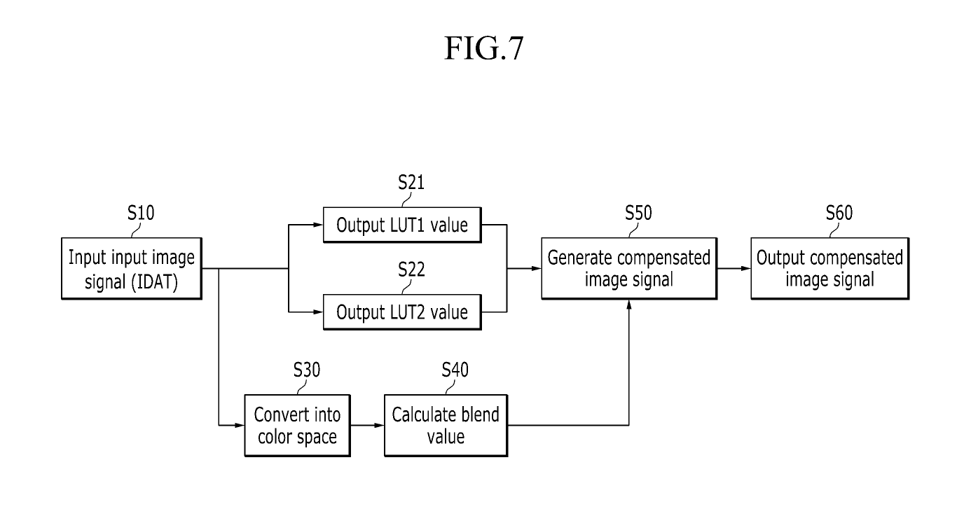

Next, a driving method including the color compensation method of the display device according to exemplary embodiments of the invention will be described in detail with reference to FIG. 7, along with the above-mentioned drawings.

FIG. 7 is a flow chart illustrating a color compensation method in the display device according to exemplary embodiments of the present invention.

First, the signal controller 600 may receive an input image signal IDAT from an external device, such as a graphic controller (S 10).

Next, the first LUT value checking unit 611 may check the first LUT 621 to obtain and output the first color compensation data (LUT1 value) for the input image signal IDAT for each primary color, each sub-pixel, or each frame (S21). The second LUT value checking unit 612 may also check the second LUT 622 to obtain and output the second color compensation data (LUT2 value) for the input image signal IDAT for each primary color, each sub-pixel, or each frame (S22).

The color space converting unit 613 may convert the input image signal IDAT into a predetermined specific color space, such as the HSV color space, and the like (S30).

The blend value calculating unit 614 may receive the HSV value converted into the HSV color space from the color space converting unit 613 to calculate the blend value VB to indicate how close the color represented by the input image signal IDAT is to a predefined specific color (S40).

The compensated image signal generating unit 615 may generate a compensated image signal IDAT′ using the first color compensation data (LUT1 value) for the input image signal IDAT obtained by the first LUT value checking unit 611, the second color compensation data (LUT2 value) for the input image signal IDAT obtained by the second LUT value checking unit 612, and the blend value VB (S50), and may output the compensated image signal IDAT′(S60).

As described above, according to exemplary embodiments of the invention, color compensation is performed by simultaneously using the first LUT 621 storing the ACC compensation data optimized for the gray-based colors, such as white, and the like, and the second LUT 622 storing the ACC compensation data optimized for a specific color, such as skin color. Therefore, in the display device that may temporally or spatially apply different gamma curves to one input image signal IDAT, the uniformity of the white color characteristics for each gray level may be maintained, and, at the same time, the uniformity of the color coordinates at the front and side of the specific color may be optimized.

According to exemplary embodiments of the invention, the first data voltage and the second data voltage are output to the display panel 300 and. When the first data voltage and the second data voltage are different from each other, it can be considered that the corresponding display device uses the first LUT 621 and the second LUT 622 according to the exemplary embodiment of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display device, comprising:
a first lookup table (LUT) configured to store first color compensation data for displaying a first color;
a second lookup table (LUT) configured to store second color compensation data for displaying a second color different from the first color; and
a color compensating unit configured to receive the first color compensation data and the second color compensation data and to convert an input image signal into a compensated image signal.

2. The display device of claim 1, wherein:
the color compensating unit comprises a color space converting unit configured to convert the input image signal into a color space.

3. The display device of claim 2, wherein:
the color compensating unit further comprises a blend value calculating unit configured to receive a value of the converted color space and to calculate a blend value indicating how close a color represented by the input image signal is to a target color.

4. The display device of claim 3, wherein:
the specific color space comprises a hue-saturation-value (HSV) color space.

5. The display device of claim 4, wherein:
the color compensating unit further comprises:
a first LUT value checking unit configured to check the first lookup table to obtain a first LUT value; and
a second LUT value checking unit configured to check the second lookup table to obtain a second LUT value, and
wherein the first LUT value corresponds to the first color compensation data for the input image signal, and the second LUT value corresponds to the second color compensation data for the input image signal.

6. The display device of claim 5, wherein:
the color compensating unit further comprises a compensated image signal generating unit configured to generate the compensated image signal according to the first LUT value, the second LUT value, and the blend value.

7. The display device of claim 6, wherein:
the compensated image signal generating unit is configured to generate the compensated image signal according to the following Equation:
Rout=VB×R_{—}spe+(1−VB)×R_white, and
wherein Rout represents the compensated image signal for a primary color, VB represents the blend value, R_spe represents the second LUT value for the primary color, and R_white represents the first LUT value for the primary color.

8. The display device of claim 7, further comprising:
a display panel configured to display an image for the input image signal, the display panel comprising a plurality of pixels,
wherein a pixel of the plurality of pixels comprises a plurality of sub-pixels configured to display an image for the input image signal respectively depending on a gamma curve or to display an image for the input image signal for a plurality of frames depending on the gamma curve.

9. The display device of claim 8, wherein:
the first lookup table is configured to store the first color compensation data for at least one of each primary color, each of the plurality of sub-pixels, and each of the plurality of frames; and
the second lookup table is configured to store the second color compensation data for at least one of each primary color, each of the plurality of sub-pixels, and each of the plurality of frames.

10. The display device of claim 3, wherein:
the color compensating unit further comprises:
a first LUT value checking unit configured to check the first lookup table to obtain the first LUT value;
a second LUT value checking unit configured to check the second lookup table to obtain the second LUT value; and
a compensated image signal generating unit configured to generate the compensated image signal using the first LUT value, the second LUT value, and the blend value, and
wherein the first LUT value corresponds to the first color compensation data for the input image signal, and the second LUT value corresponds to the second color compensation data for the input image signal.

11. A driving method of a display device, the driving method comprising:
converting an input image signal into a compensated image signal according to a first color compensation data stored in a first lookup table (LUT) and a second color compensation data stored in a second lookup table (LUT),
wherein the first color compensation data comprises data for displaying a first color, and the second color compensation data comprises data for displaying a second color different from the first color.

12. The driving method of claim 11, wherein:
converting the input image signal into the compensated image signal comprises converting the input image signal into a specific color space.

13. The driving method of claim 12, wherein:
converting the input image signal into the compensated image signal further comprises receiving a value of the converted color space to calculate a blend value indicating how close a color represented by the input image signal is to a target color.

14. The driving method of claim 13, wherein:
the specific color space comprises a hue-saturation-value (HSV) color space.

15. The driving method of claim 14, wherein:
converting the input image signal into the compensated image signal further comprises:
checking the first lookup table to obtain a first LUT value; and
checking the second lookup table to obtain a second LUT value, and
wherein the first LUT value corresponds to the first color compensation data for the input image signal, and the second LUT value corresponds to the second color compensation data for the input image signal.

16. The driving method of claim 15, wherein:
converting the input image signal into the compensated image signal further comprises generating the compensated image signal according to the first LUT value, the second LUT value, and the blend value.

17. The driving method of claim 16, wherein:
generating the compensated image signal comprises determining the compensated image signal using the following Equation:
Rout=VB×R_{—}spe+(1−VB)×R_white, and
wherein Rout represents the compensated image signal for a primary color, VB represents the blend value, R_spe represents the second LUT value for the primary color, and R_white represents the first LUT value for the primary color.

18. The driving method of claim 17, further comprising:
displaying, in the display device, an image for the input image signal,
wherein the display device comprises a display panel having a plurality of pixels, a pixel of the plurality of pixels comprising a plurality of sub-pixels, and
wherein the image is displayed by the plurality of sub-pixels respectively depending on a gamma curve or for a plurality of frames depending on the gamma curve.

19. The driving method of claim 18, further comprising:
storing, in the first lookup table, the first color compensation data for at least one of each primary color, each of the plurality of sub-pixels, and each of the plurality of frames; and
storing, in the second lookup table, the second color compensation data for at least one of each primary color, each of the plurality of sub-pixels, and each of the plurality of frames.

20. The driving method of claim 13, wherein:
converting the input image signal into the compensated image signal further comprises:
checking the first lookup table to obtain a first LUT value;
checking the second lookup table to obtain a second LUT value; and
generating the compensated image signal using the first LUT value, the second LUT value, and the blend value, and
wherein the first LUT value corresponds to the first color compensation data for the input image signal, and the second LUT value corresponds to the second color compensation data for the input image signal.
